(19) United States
(12) Patent Application Publication
(10) Pub. No.: US 2017/0300819 A1
(43) Pub. Date: Oct. 19, 2017

(54) Time-Series Prediction Apparatus and Time-Series Prediction Method

(71) Applicant: Hitachi, Ltd., Chiyoda-ku, Tokyo (JP)

(72) Inventors: Yu HAYASHI, Tokyo (JP); Naofumi TOMITA, Tokyo (JP); Masao ISHIGURO, Tokyo (JP); Kazushige HIROI, Tokyo (JP)

(21) Appl. No.: 15/513,749

(22) PCT Filed: Oct. 21, 2014
(86) PCT No.: PCT/JP2014/077916

§ 371 Date: Mar. 23, 2017

(51) Int. Cl. G06N 5/04

(52) U.S. Cl. CPC G06N 5/04

(57) ABSTRACT

A time-series prediction apparatus 10, which is an information processing apparatus that predicts transition of time-series data on a matter, calculates a relevance level which is an index of strength of a causal relation between a plurality of matters including a prediction target matter, based on time-series data relevant to each of the matters and on time-series data relevant to the causal relation between the matters, and predicts transition of the time-series data relevant to the matter based on the calculated relevance level. The time-series prediction apparatus 10 calculates the relevance level based on collocation frequency of terms relevant to the respective matters in the time-series data relevant to the causal relation between the matters. The time-series prediction apparatus 10 builds multiple prediction models for predicting the transition of the time-series data relevant to the prediction target matter based on time-series data relevant to a matter which is in a causal relation with the prediction target matter, and integrates prediction results of the respective prediction models while weighing each of the prediction models according to the relevance level.

### TECHNICAL FIELD

The present invention relates to a time-series prediction apparatus and time-series prediction method.

### BACKGROUND ART

Patent Literature 1 describes the following: “A first data collection means acquires time-series text data covering a predetermined period. Based on the time-series text data, a first assessment value calculation means calculates time-series assessment values for each target. A second data collection means acquires time-series numerical data covering the predetermined period. Based on the time-series numerical data, a change rate calculation means calculates time-series change rates for each target. A third data collection means collects text information published after the predetermined period. Based on the text information collected, a second assessment value calculation means calculates an assessment value for each target. Based on the time-series assessment values, the time-series change rates, and the assessment value that are calculated for each target, an attention level calculation means calculates the noteworthiness of the target. The presentation means presents the attention level of each target.”

### CITATION LIST

### Patent Literature

[PTL 1]Japanese Patent Application Laid-open Publication No. 2012-79227

### SUMMARY OF INVENTION

### Technical Problem

In recent years, various kinds of time-series data related to social trends have been published, such as data in government statistics, news articles, posts on SNS (Social Networking Service). There have been proposed techniques for predicting the temporal transition of a particular matter related to a social trend by using such time-series data. Predicting a social trend based on such a technique and making use of the results in making business plans for marketing or the like enable starting a profitable business that fits with the change in the social trend.

Prediction of the transition of a matter related to a social trend can be achieved by, for example, predicting the transition of time-series data related to the prediction target matter based on various kinds of time-series data inputted in relation to the social trend. For example, for prediction of the transition of a matter “increase in the number of foreigners”, a prediction model for predicting the transition of “the number of foreigners” may be built by using time-series data related to “increase in the number of foreigners” in government statistics, news articles, SNS posts, and the like. If the prediction target is a change in a social trend, which is considered to occur in association with multiple matters, it is important to take a causal relation between the matters into account in order to predict the transition of time-series data related to the prediction target matter with high accuracy.

The technique disclosed in Patent Literature 1 builds a prediction model based on data obtained in the past on the assumption that the causal relation between the matters is fixed. For this reason, if the causal relation between the matters changes after the prediction model is built, the prediction turns out to be less accurate.

The present invention has an object to provide a time-series prediction apparatus and a time-series prediction method capable of predicting the transition of a matter with high accuracy by considering the transition of a causal relation between the matters.

### Solution to Problem

One of modes of the present invention for achieving the above object is an information processing apparatus that predicts transition of time-series data on a matter, the apparatus comprising: a relevance level calculation part that calculates a relevance level which is an index of strength of a causal relation between a plurality of matters including a prediction target matter, based on time-series data relevant to each of the matters and on time-series data relevant to the causal relation between the matters; and a transition prediction part that predicts transition of the time-series data relevant to the matter based on the relevance level.

Other problems disclosed by the present application and means for solving the problems will become apparent in the Description of Embodiments section and the drawings.

### Advantageous Effects of Invention

The present invention can predict the transition of a matter with high accuracy by considering the transition of the causal relation between the matters.

### BRIEF DESCRIPTION OF DRAWINGS

FIG. 1 is an example of multiple matters having causal relations.

FIG. 2 is a diagram illustrating the hardware configuration of a time-series prediction apparatus 10.

FIG. 3 is a data-flow diagram illustrating functions (the software configuration) of and data managed by the time-series prediction apparatus 10.

FIG. 4 is an example of causal relation data 121.

FIG. 5 is an example of time-series text data 1221.

FIG. 6 is an example of time-series numerical data 1222.

FIG. 7 is a flowchart illustrating time-series data collection processing S700.

FIG. 8 is an example of relevance level data 123.

FIG. 9 is a flowchart illustrating relevance level calculation processing S900.

FIG. 10 is a flowchart illustrating first feature amount calculation processing S902.

FIG. 11 is an example of a formula for use in calculation of a first feature amount.

FIG. 12 is a flowchart illustrating second feature amount calculation processing S903.

FIG. 13 is an example of transition index data 124.

FIG. 14 is a flowchart illustrating transition prediction processing S1400.

FIG. 15 is an example of a prediction model built using a transition index.

FIG. 16 is an example of a prediction model built using time-series data 122.

FIG. 17 is an example of a formula for integrating prediction results based on relevance levels.

FIG. 18 is a flowchart illustrating prediction result display processing S1800.

FIG. 19 is an example of a settings screen 1900.

FIG. 20 is an example of a prediction result display screen 2000.

### DESCRIPTION OF EMBODIMENTS

An embodiment is described in detail below using the drawings.

A time-series prediction apparatus described below collects time-series data relevant to each of multiple matters including a prediction target matter, and time-series data relevant to a causal relation between the matters, and using the time-series data collected, calculates the level of relevance which is an index of the strength of the causal relation between matters. The time-series prediction apparatus then predicts the transition of the time-series data relevant to the prediction target matter while taking the influence of the causal relation between the matters into account based on the relevance level calculated.

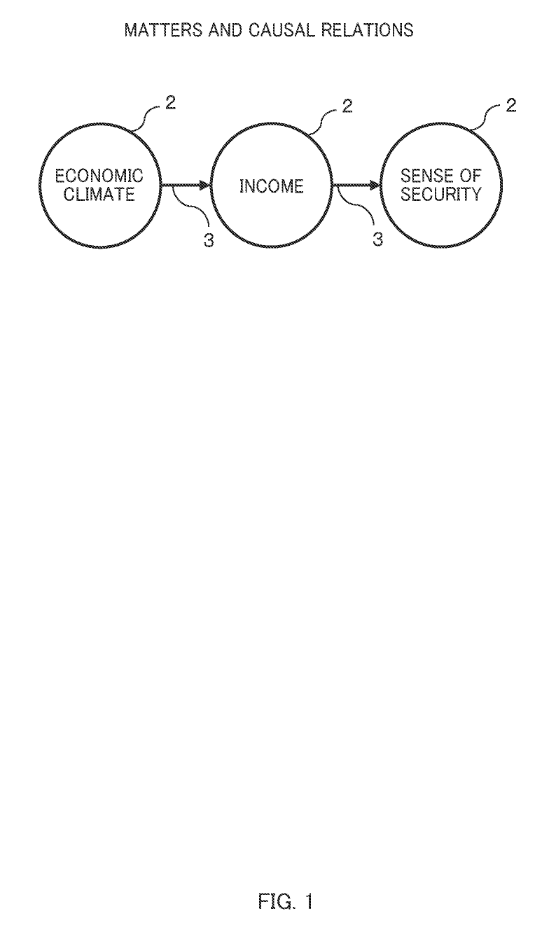

FIG. 1 illustrates an example of multiple matters having causal relations. In FIG. 1, circles having words “economic climate”, “income”, and “sense of security” in them are nodes 2 corresponding to matters, and edges 3 connecting the nodes 2 represent the causal relation between the matters. The time-series prediction apparatus collects time-series data relevant to each of these matters and causal relations from the Internet, and using the time-series data thus collected, calculates the strength of the causal relation between the matters as a relevance level. For example, if a prediction target matter (a child node) is “sense of security” in FIG. 1, the time-series prediction apparatus collects, from the Internet, time-series data such as SNS (Social Networking Service) data, news data, average personal income, the impact of income on living, and calculates the strength of a causal relation between the child node and its parent node “income”, as the level of relevance between the matters.

The time-series prediction apparatus calculates the relevance level by using, for example, the collocation frequency of terms (keywords) relevant to the respective matters observed in the time-series data relevant to the causal relation between the matters. The time-series prediction apparatus performs the transition prediction by building multiple prediction models for predicting the transition of time-series data relevant to a prediction target matter, based on time-series data relevant to a matter having a causal relation with the prediction target matter, weighing each of the prediction models according to the relevance levels calculated, and integrating prediction results of the respective prediction models.

As described, the time-series prediction apparatus predicts the transition of time-series data using the relevance level while taking the transition of a causal relation between matters (for example, a change in the causal relation due to a factor such as increase in the consumption tax rate) as the transition of a relevance level. This allows highly-accurate prediction of, for example, the transition of time-series data on a social trend. The thus-obtained prediction results are useful in starting a profitable business that fits with the change in social trends, when used in, for example, making business plans for marketing or the like.

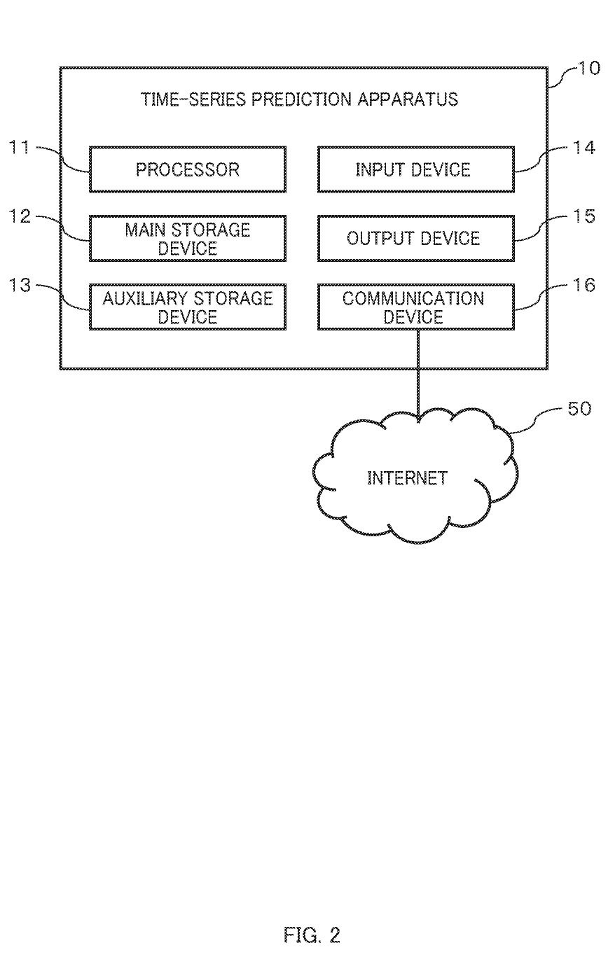

FIG. 2 illustrates the hardware configuration of the time-series predication apparatus. A time-series prediction apparatus 10 is an information processing apparatus (a computer), and includes a processor 11, a main storage device 12, an auxiliary storage device 13, an input device 14, an output device 15, and a communication device 16. They are communicatively coupled via communication means such as buses.

The processor 11 is configured using, for example, a CPU (Central Processing Unit), an MPU (Micro Processing Unit), or the like. The main storage device 12 is a device that stores programs and data, and is, for example, a ROM (Read Only Memory), a RAM (Random Access Memory), NVRAM (Non Volatile RAM), or the like. The auxiliary storage device 13 is a hard disk drive, an SSD (Solid State Drive), an optical storage device, or the like. Programs and data stored in the auxiliary storage device 13 are loaded onto the main storage device 12 when needed.

The input device 14 is a user interface that receives input of information and instructions from a user, and is, for example, a keyboard, a mouse, a touch panel, or the like. The output device 15 is a user interface that provides the user with information, and is, for example, a graphic card, a liquid crystal monitor, or the like. The communication device 16 is a communication interface used for communications with another apparatus via an Internet 50, and is, for example, a NIC (Network Interface Card) or a wireless LAN interface.

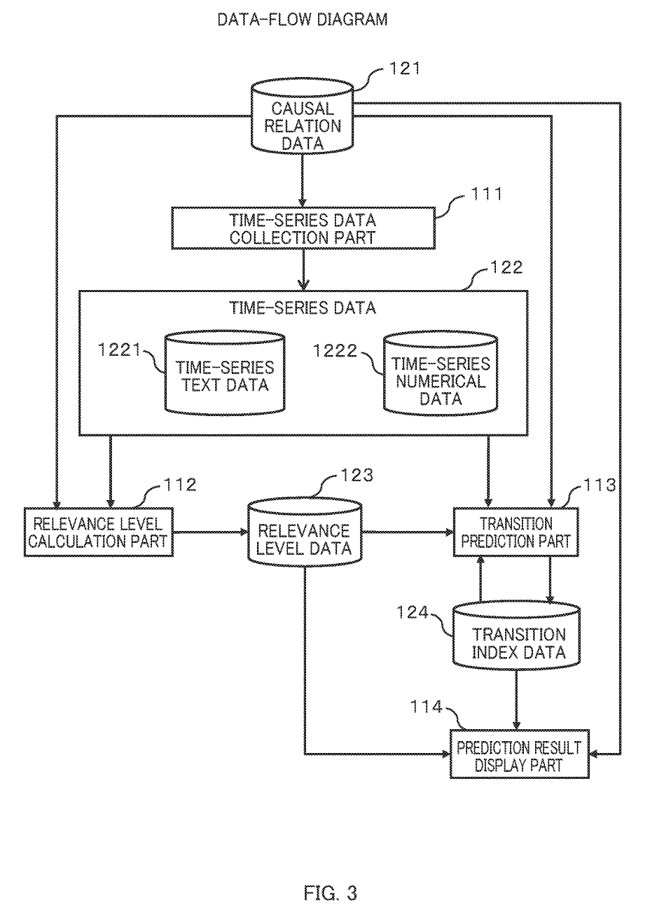

FIG. 3 is a data-flow diagram illustrating functions (the software configuration) of and data managed by the time-series prediction apparatus 10. As shown in FIG. 3, the time-series prediction apparatus 10 includes a time-series data collection part 111, a relevance level calculation part 112, a transition prediction part 113, and a prediction result display part 114. These functions are implemented when the processor 11 reads the programs stored in the main storage device 12 and executes them.

In addition, as shown in FIG. 3, the time-series prediction apparatus 10 stores therein causal relation data 121, time-series data 122 (time-series text data 1221 and time-series numerical data 1222), relevance level data 123, and transition index data 124. These kinds of data are managed by, for example, a DBMS (Data Base Management System) functioning in the time-series prediction apparatus 10.

Of the functions shown in FIG. 3, the time-series data collection part 111 refers to the causal relation data 121, including data on matters and data on causal relations between the matters, and collects the time-series text data 1221 and the time-series numerical data 1222 over the Internet 50. The causal relation data 121 is created by, for example, a user of the time-series prediction apparatus 10 in advance.

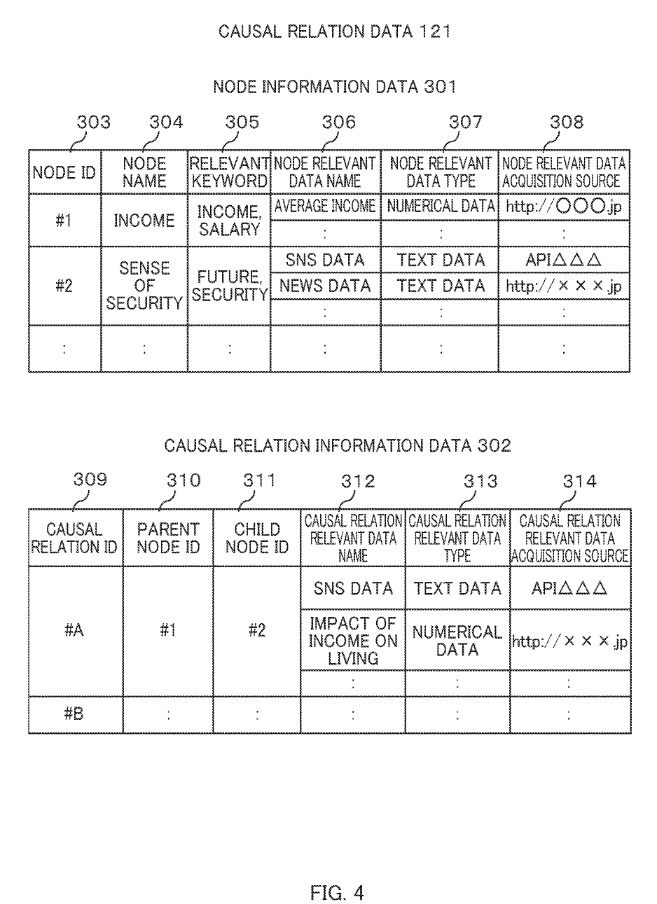

FIG. 4 illustrates an example of the causal relation data 121. As shown in FIG. 4, the causal relation data 121 includes node information data 301, which is information on matters, and causal relation information data 302, which is information on causal relations between the matters.

In FIG. 4, a node ID 303 of the node information data 301 is an identifier for distinguishing a matter (node) from the other matters (such an identifier is called a node ID hereinafter). A node name 304 is the name of the matter. A relevant keyword 305 is a group of terms relevant to the matter. A node relevant data name 306 is the name of data relevant to the matter (hereinafter called node relevant data). A node relevant data type 307 is the type of the node relevant data. A node relevant data acquisition source 308 is information indicating where to acquire the node relevant data. Examples of the node relevant data type 307 include “numerical data” and “text data”. The node relevant data acquisition source 308 is, for example, “http:ooo.jp” which is an URL (Uniform Resource Locator) where the node relevant data is uploaded, or “API ΔΔΔ”, which is an API (Application Programming Interface) used to acquire the node relevant data.

In the causal relation information data 302 in FIG. 4, a causal relation ID 309 is an identifier for distinguishing a causal relation from the other causal relations. A parent node ID 310 is the ID of the parent node of two matters (nodes) forming a causal relation, and a child node ID 311 is the ID of the child node of the two matters (nodes) forming the causal relation. A causal relation relevant data name 312 is the name of data relevant to the causal relation (hereinafter called causal relation relevant data). A causal relation relevant data type 313 is the type of the causal relation relevant data. A causal relation relevant data acquisition source 314 is information indicating where to acquire the causal relation relevant data.

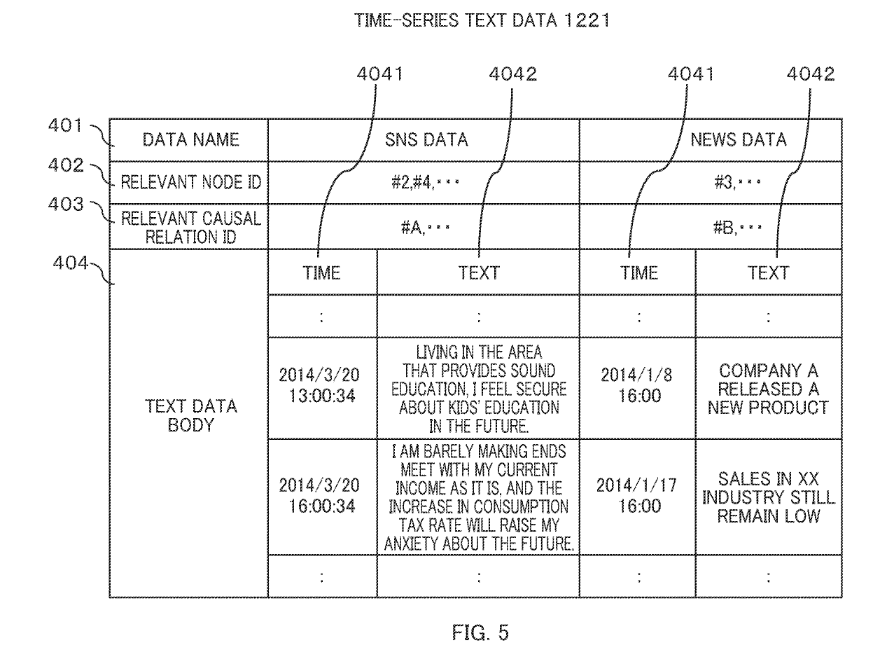

FIG. 5 illustrates an example of the time-series text data 1221 collected by the time-series data collection part 111. In FIG. 5, a data name 401 corresponds to the node relevant data name 306 of the node information data 301 or the causal relation relevant data name 312 of the causal relation information data 302. As an example, FIG. 5 shows two pieces of time-series text data 1221: one having “SNS data” as the data name 401 and one having “news data” as the data name 401. A relevant node ID 402 is the node ID 303 of a matter relevant to the time-series text data 1221. A relevant causal relation ID 403 is the causal relation ID 309 of the causal relation information data 302 relevant to the time-series text data 1221. A text data body 404 is the body of the time-series text data 1221 and has items: time 4041 and text 4042. If, for example, the time-series text data 1221 is a microblog, the time 4041 indicates the time (time and date) when a post is put up on the microblog, and the text 4042 indicates the body of the post on the microblog.

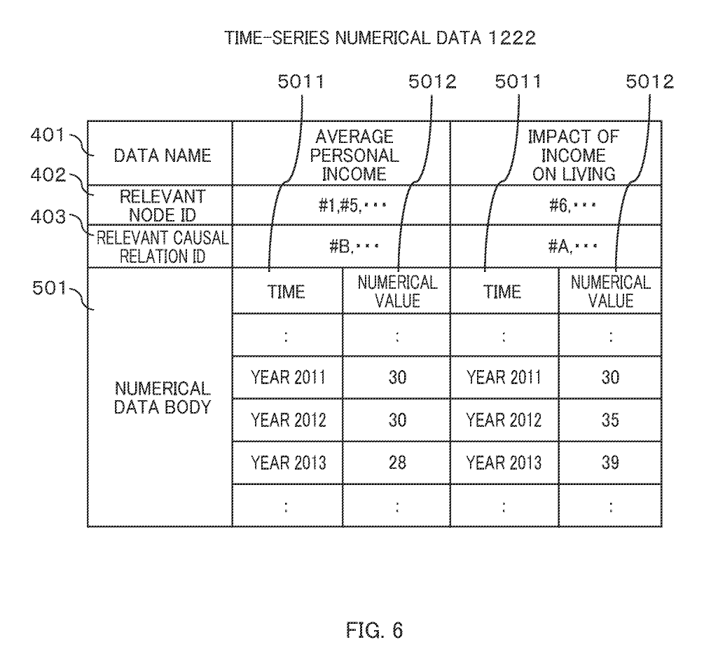

FIG. 6 illustrates an example of the time-series numerical data 1222 generated by the time-series data collection part 111. Elements of the time-series numerical data 1222 which are denoted by the same reference numerals as those in FIG. 5 are the same elements as those in FIG. 5, and are therefore not described below to avoid repetition. As an example, FIG. 6 illustrates two pieces of time-series numerical data 1222: one having “average personal income” as the data name 401 and one having “impact of income on living” as the data name 401. A numerical data body 501 is the body of the time-series numerical data 1222, and further includes items: time 5011 and numerical value 5012. For example, for the time-series numerical data 1222 having “average personal income” as the data name 401, the time 5011 indicates the fiscal year for which information (e.g., an average annual income) is acquired, and the numerical value 5012 is the information acquired (e.g., an average annual income).

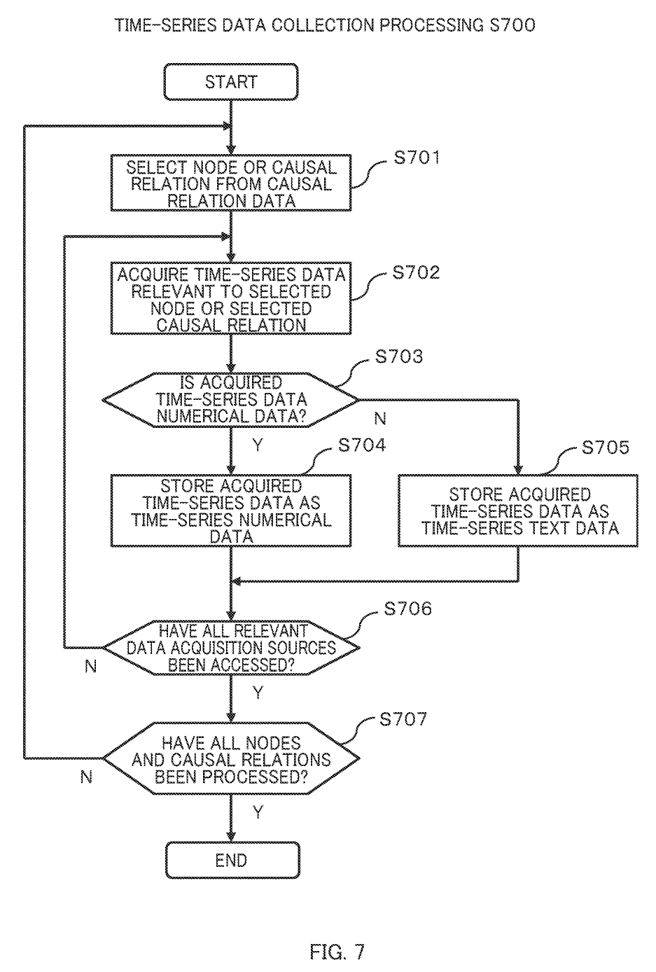

FIG. 7 is a flowchart illustrating processing performed by the time-series data collection part 111 shown in FIG. 3 (hereinafter called time-series data collection processing S700). The time-series data collection processing S700 is described below using FIG. 7.

First, from the causal relation data 121, the time-series data collection part 111 selects either a node in node information data 301 (a record identified by the node ID 303) or a causal relation in the causal relation information data 302 (a record identified by the causal relation ID 309) (S701).

Next, over the Internet 50, the time-series data collection part 111 acquires the time-series data 122 by accessing the node relevant data acquisition source 308 of the node selected in S701 or the causal relation relevant data acquisition source 314 of the causal relation selected in S701 (S702).

Then, the time-series data collection part 111 determines whether the node relevant data type 307 of the node selected in S701 or the causal relation relevant data type 313 of the causal relation selected in S701 is numerical data (S703). If the node relevant data type 307 selected in S701 or the causal relation relevant data type 313 selected in S701 is numerical data (S703: Y), the time-series data collection part 111 stores the time-series data 122 acquired in S702 as the time-series numerical data 1222 (S704). When the node relevant data type 307 selected in S701 or the causal relation relevant data type 313 selected in S701 is not numerical data (S703: N), the time-series data collection part 111 stores the time-series data 122 acquired in S702 as the time-series text data 1221 (S705).

The time-series data collection part 111 repeats the above processing to acquire all the data relevant to the selected node or causal relation (S706).

The time-series data collection part 111 repeats the above processing until all the records in the causal relation data 121 (all the nodes and all the causal relations) are processed (S707).

FIG. 3 is referred to again to continue the description. The relevance level calculation part 112 generates the relevance level data 123, which is data indicating the strength of a causal relation between nodes, by referring to the causal relation data 121 as well as the time-series data 122 (the time-series text data 1221 and the time-series numerical data 1222).

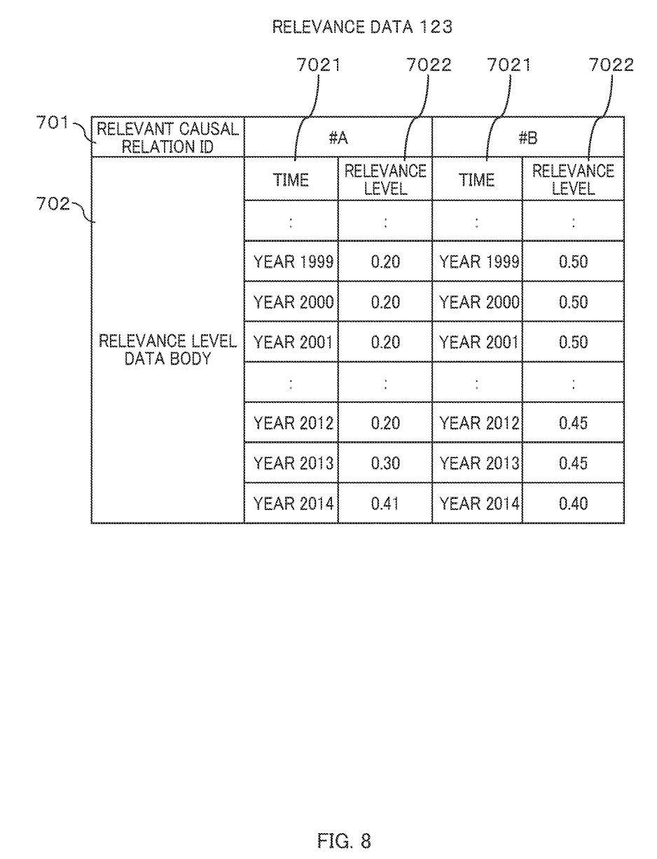

FIG. 8 illustrates an example of the relevance level data 123. In the relevance level data 123, a relevant causal relation ID 701 corresponds to the causal relation ID 309 of the causal relation information data 302 of the causal relation data 121. A relevance level data body 702 has the items: time 7021 and relevance level 7022. The time 7021 indicates the time for the relevance level 7022, and the relevance level 7022 is an index (relevance level) indicating the strength of the causal relation at the corresponding time 7021.

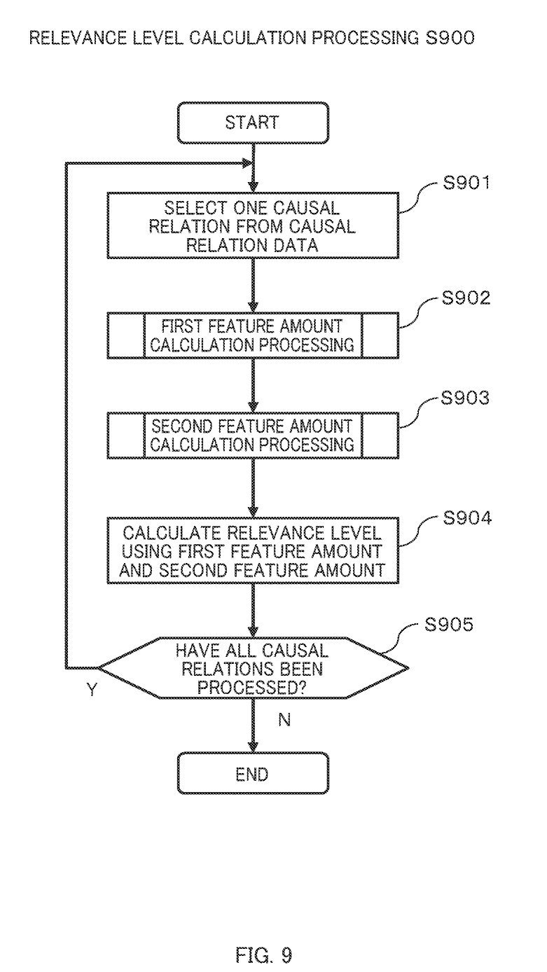

FIG. 9 is a flowchart illustrating processing performed by the relevance level calculation part 112 (hereinafter referred to as relevance level calculation processing S900). The relevance level calculation processing S900 is described below using FIG. 9.

First, the relevance level calculation part 112 selects a causal relation in the causal relation information data 302 (a record identified by the node ID 303) (S901).

Next, the relevance level calculation part 112 calculates a first feature amount, which is an index of the strength of a causal relation, using the time-series text data 1221 relevant to the selected causal relation and the node information data 301 relevant to the selected causal relation (S902).

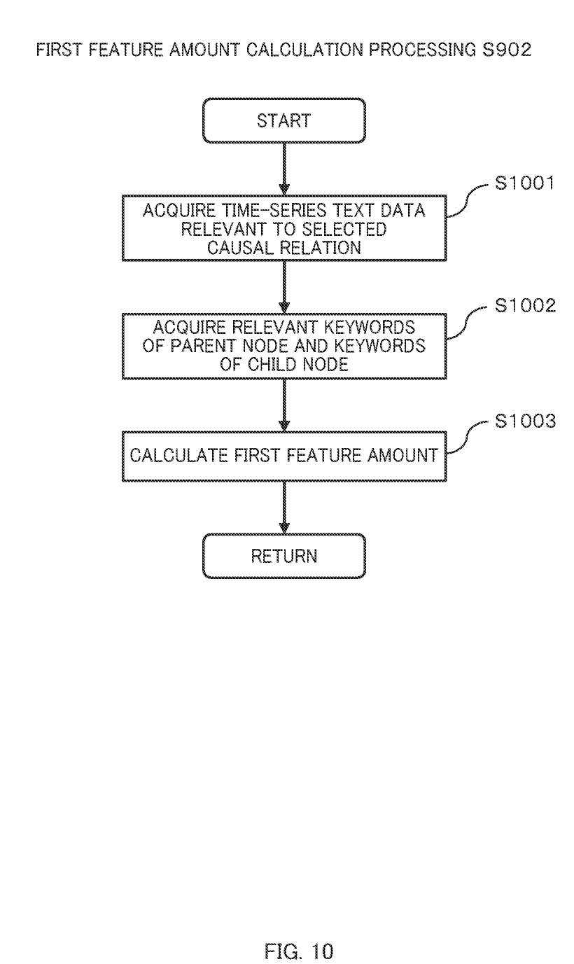

FIG. 10 is a flowchart illustrating processing for calculating the first feature amount (hereinafter called first feature amount calculation processing S902). The first feature amount calculation processing S902 is described below using FIG. 10.

First, the relevance level calculation part 112 refers to the relevant causal relation ID 403 of the time-series text data 1221, and acquires the time-series text data 1221 relevant to the causal relation selected in S901 (S1001). For example, when the causal relation selected in S901 is one with the causal relation ID 309 “#A” shown in FIG. 4, the relevance level calculation part 112 acquires, from the time-series text data 1221, the time-series text data 1221 containing “#A” as the relevant causal relation ID 403 (in FIG. 5, the time-series text data 1221 having “SNS data” as the data name 401).

Next, the relevance level calculation part 112 acquires relevant keywords of each of the parent node and the child node of the causal relation (S1002). For example, when the causal relation selected in S901 is one with the causal relation ID 309 “#A” shown in FIG. 4, the parent node ID 310 is “#1” and the child node ID 311 is “#2”. Thus, the relevance level calculation part 112 acquires, from the node information data 301, “income, salary” as the relevant keywords 305 of the parent node, and “future, security” as the relevant keywords 305 of the child node.

Then, using a predetermined method, the relevance level calculation part 112 calculates the first feature amount as an index of the strength of the causal relation (S1003).

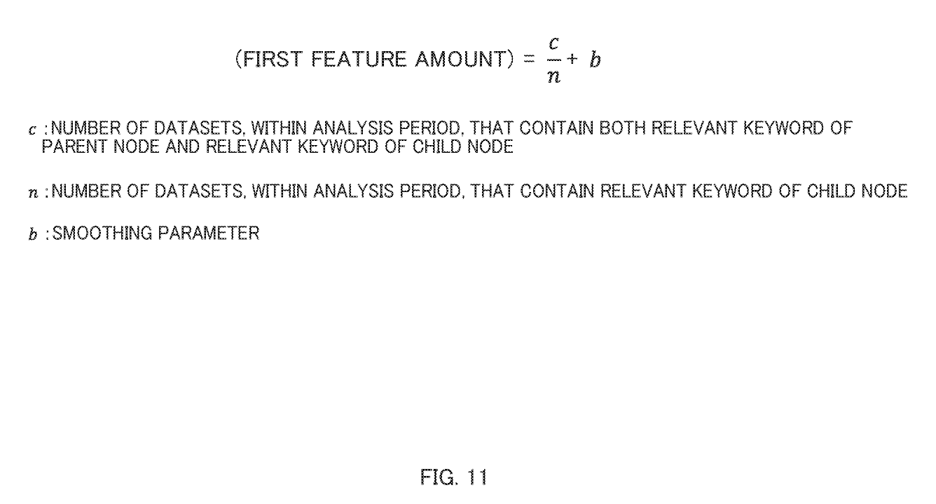

FIG. 11 illustrates an example of a formula for use in the calculation of the first feature amount. The relevance level calculation part 112 calculates the first feature amount based on the collocation frequency of the relevant keyword 305 of the parent node and the relevant keyword 305 of the child node observed in the acquired time-series text data 1221 within a certain period. For example, the period of analysis used in the calculation of the collocation frequency is designated by a user of the time-series prediction apparatus 10 using a settings screen 1900 to be described later. The calculation of the relevance level uses only the time-series text data 1221 at the current time to the time-series text data 1221 dating back the analysis period. If, for example, the current time is “Mar. 30, 2014” and the designated unit of analysis is “30 days”, the relevance level calculation part 112 calculates the relevance level using the time-series text data 1221 in the period from “Mar. 1, 2014” to “Mar. 30, 2014”.

The value c in FIG. 11 is, in the example where the target causal relation is one with the causal relation ID 309 “#A” shown in FIG. 4 is selected, the number of datasets in the time-series text data 1221, for the past 30 days, that contain one of the relevant keywords 305 of the parent node, “income, salary”, and also contains one of the relevant keywords 305 of the child node, “future, security”. The value n in the calculation formula in FIG. 11 is the number of datasets in the time-series text data 1221, for the past 30 days, that contain one of the relevant keywords 305 of the child node, “future, security”. The value b in the calculation formula in FIG. 11 is a smoothing parameter for preventing the relevance level from resulting in “0”, and is set by, for example, a user of the time-series prediction apparatus 10 in advance.

For example, the first feature amount in the causal relation with the causal relation ID 309 “#A” shown in FIG. 4 is given as (40/100)+0.01=0.41 when 40 pieces of data contain one of the keywords “income, salary” and one of the keywords “future, security” and 100 sets of data contain one of the keywords “future, security”, in the following conditions: the current time is “Mar. 30, 2014”, the unit of analysis is “30 days”, the value b of the smoothing parameter is “0.01”, the time-series data is one with the data name 401 “SNS data” in FIG. 5, and the period is from “Mar. 1, 2014” to “Mar. 30, 2014”.

If there is no time-series text data 1221 that is relevant to the causal relation selected in S901, the relevance level calculation part 112 sets the first feature amount to, for example, b (smoothing parameter). If there are more than one set of time-series text data 1221 that is relevant to the target causal relation, the relevance level calculation part 112 obtains a feature amount for each set of the time-series text data 1221 using the formula in FIG. 11, and uses the average of the feature amounts obtained for all the sets of the time-series text data 1221 as the first feature amount. Alternatively, the relevance level calculation part 112 may set a different weight for each set of time-series text data 1221, calculate feature amounts for the respective sets of the time-series text data 1221 using the formula shown in FIG. 11, weigh the feature amounts by the respective weights, and use the average of the weighed feature amounts as the first feature amount.

Referring back to FIG. 9, the relevance level calculation part 112 next obtains a second feature amount, which is an index of the strength of a causal relation, using the time-series numerical data 1222 relevant to the causal relation (S903).

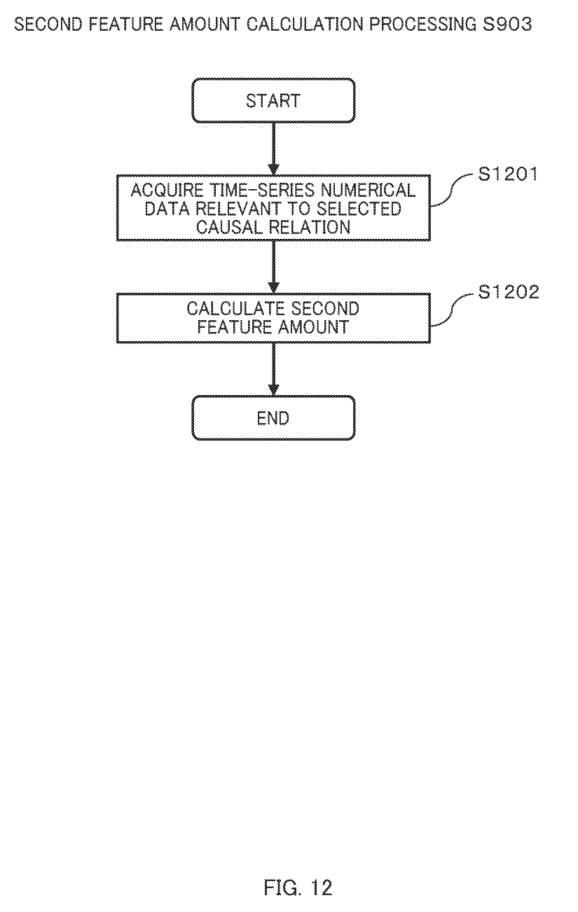

FIG. 12 is a flowchart illustrating processing for calculating the second feature amount (hereinafter called second feature amount calculation processing S903). The second feature amount calculation processing S903 is described below using FIG. 12.

First, the relevance level calculation part 112 refers to the relevant causal relation ID 403 of the time-series numerical data 1222 and acquires the time-series numerical data 1222 relevant to the causal relation (S1201). If, for example, the causal relation selected in S901 is one with the causal relation ID 309 “#A” shown in FIG. 4, the relevance level calculation part 112 acquires, from the time-series numerical data 1222 shown in FIG. 6, the time-series numerical data 1222 containing “#A” as the relevant causal relation ID 403, namely, the time-series text data 1221 under the name “impact of income on living”.

Next, the relevance level calculation part 112 obtains the second feature amount (S1202). The second feature amount is obtained by, for example, division of the average of numerical values in the time-series numerical data 1222 for the past one year by a predetermined value. For instance, if the current time is “Apr. 1, 2014” and the causal relation selected in S901 is one with the causal relation ID 309 “#A” in FIG. 4, the relevance level calculation part 112 picks up the numerical value 5012 of the year 2013, “39”, among the data pieces under “impact of income on life” shown in FIG. 6 and divides this “39” by a predetermined value “100”, obtaining “0.39” as the second feature amount.

If there is no time-series numerical data 1222 that is relevant to the causal relation selected in S901, the relevance level calculation part 112 sets the second feature amount to, for example, “0”. If more than one set of time-series numerical data 1222 is selected in S901 as being relevant to the target causal relation, the relevance level calculation part 112, for example, calculates a feature amount for each set of the time-series numerical data 1222, and uses the average of all the datasets as the second feature amount. Alternatively, the relevance level calculation part 112 may set a different weight for each set of the time-series numerical data 1222, calculate feature amounts for the respective sets of the time-series numerical data 1222, weigh the feature amounts by the respective weights, and use the average of the weighed feature amounts as the second feature amount.

Referring back to FIG. 9, the relevance level calculation part 112 next calculates the relevance level using the first feature amount and the second feature amount thus obtained (S904). For example, the relevance level calculation part 112 uses the average of the first feature amount and the second feature amount as the relevance level. In the example where the causal relation selected in S901 is one with the causal relation ID 309 “#A” shown in FIG. 4, the first feature amount is “0.41” and the second feature amount is “0.39”. Hence, the relevance level calculation part 112 calculates the relevance level to be (0.41+0.39)/2=0.40.

The relevance level calculation part 112 calculates the relevance level of every causal relation in the causal relation data 121 by repeating the above processing for every causal relation (S905).

FIG. 3 is referred to again to continue the description. The transition prediction part 113 predicts the transition of a transition index, which is an index related to the transition of a matter, using the data stored in the causal relation data 121, the relevance level data 123, and the transition index data 124, and generates the transition index data 124 as a prediction result.

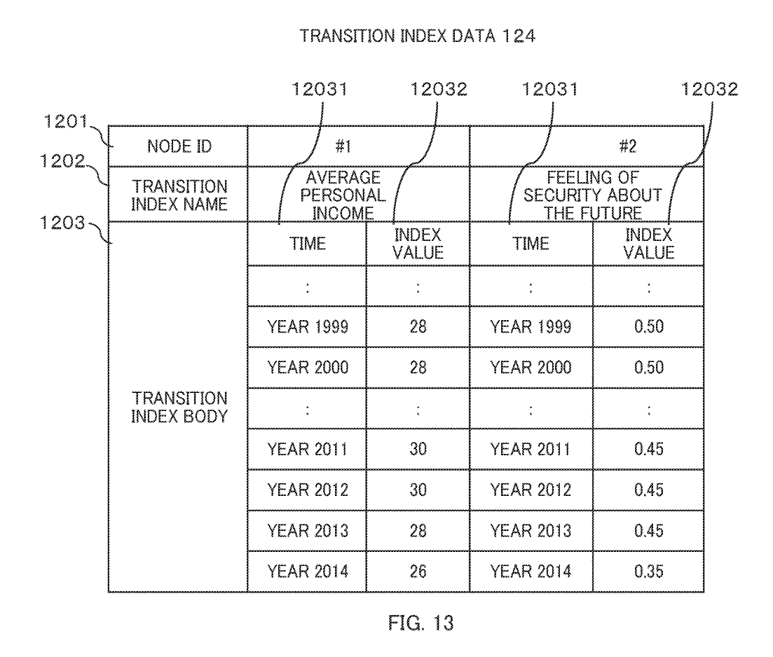

FIG. 13 illustrates an example of the transition index data 124. A node ID 1201 of the transition index data 124 corresponds to the node ID 303 of the causal relation data 121 for a transition index body 1203. A transition index name 1202 indicates the name of a transition index. The transition index body 1203 is the body of the transition index, and includes the items: time 12031 and index value 12032 to indicate the size of the transition index for particular time.

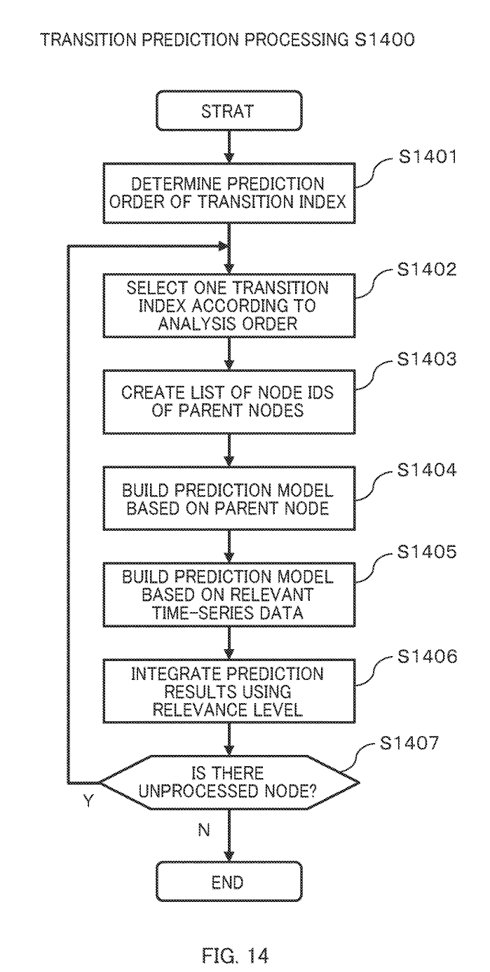

FIG. 14 is a flowchart illustrating processing performed by the transition prediction part 113 (hereinafter called transition prediction processing S1400). The transition prediction processing S1400 is described below using FIG. 14.

The transition prediction part 113 determines the prediction order for a transition index (S1401). The transition prediction part 113 determines the transition index prediction order by, for example, reading a prediction order preset by a user of the time-series prediction apparatus 10. For instance, in the matters exemplified in FIG. 1, the transition prediction part 113 sets the prediction order to “economic climate”->“income”->“security”.

Next, the transition prediction part 113 selects one transition index according to the prediction order determined in S1401 (S1402).

Next, the transition prediction part 113 acquires the node ID 1201 of the transition index selected, and creates a list of the node IDs of parent nodes (S1403). The transition prediction part 113 creates the list of the node IDs of parent nodes by acquiring, from the causal relation information data 302, the parent node ID 310 which is in a causal relation with the child node ID 311 corresponding to the node ID 1201. If, for example, “feeling of security about the future” is selected in S1402 from the transition index data 124 in FIG. 13 as the transition index, the transition prediction part 113 acquires the parent node ID 310 “#1” of the causal relation ID 309 “#A” from the causal relation information data 302 in FIG. 4 because the parent node ID 310 “#1” is in a causal relation with the child node ID 311 “#2” which corresponds to the node ID 1201 “#2” of the transition index data 124. The transition prediction part 113 then registers the node ID 1201 “#2” on the list of the node IDs of parent IDs.

Next, the transition prediction part 113 uses the transition index of the parent node acquired in S1403 to build a prediction model for use in the transition prediction of the transition index selected in S1402 (S1404). If there are more than one transition index corresponding to the parent node, the transition prediction part 113 builds multiple prediction models, using the transition index selected in S1402 and each of the transition indices of the respective parent nodes.

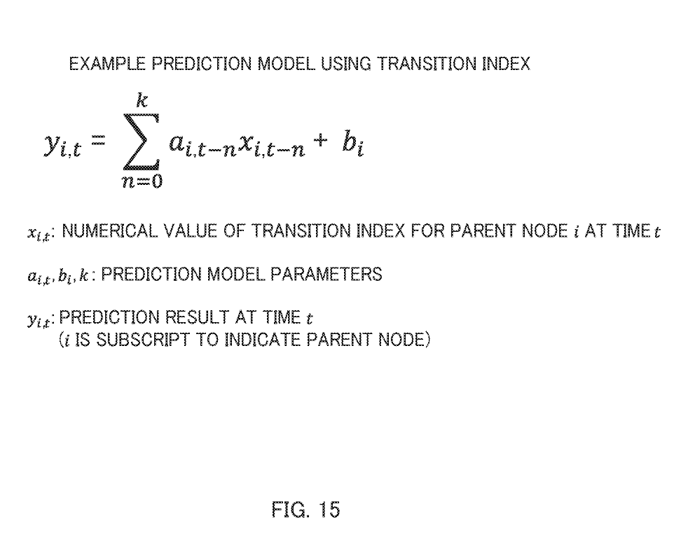

FIG. 15 illustrates an example of a prediction model built using transition indices. In the example where “feeling of security about the future” is selected in S1402 from the transition indices shown in FIG. 13, the transition prediction part 113 builds a model for predicting “feeling of security about the future” using “average personal income”, which is a transition index corresponding to the node ID 310 “#1”.

Referring back to FIG. 14, using the time-series data relevant to the node corresponding to the transition index selected in S1402, the transition prediction part 113 builds a prediction model for predicting the transition of the transition index selected in S1402 (S1405). First, the transition prediction part 113 refers to the relevant node ID 402 in the time-series text data 1221 shown in FIG. 5 and the time-series numerical data 1222 shown in FIG. 6, and acquires the time-series data 122 relevant to the node corresponding to the transition index selected in S1402. Using the time-series data 122 thus acquired, the transition prediction part 113 builds a prediction model for predicting the transition of the transition index selected in 1402.

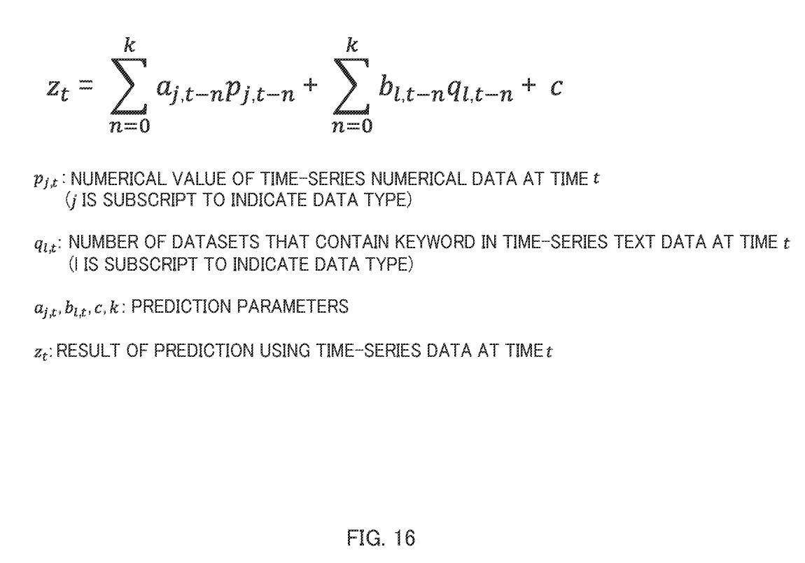

FIG. 16 illustrates an example of a prediction model built using the time-series data 122. In the example where “feeling of security about the future” is selected in S1402 from the transition indices shown in FIG. 13, the transition prediction part 113 acquires “SNS data” in FIG. 5 whose node ID 402 is “#2”. Since “SNS data” is the time-series text data 1221, the transition prediction part 113 tallies the number of data pieces containing one of the relevant keywords 305 of the node, “future, security”, in the “SNS data” for “30 days” which is the unit of analysis, and thereby builds a prediction model.

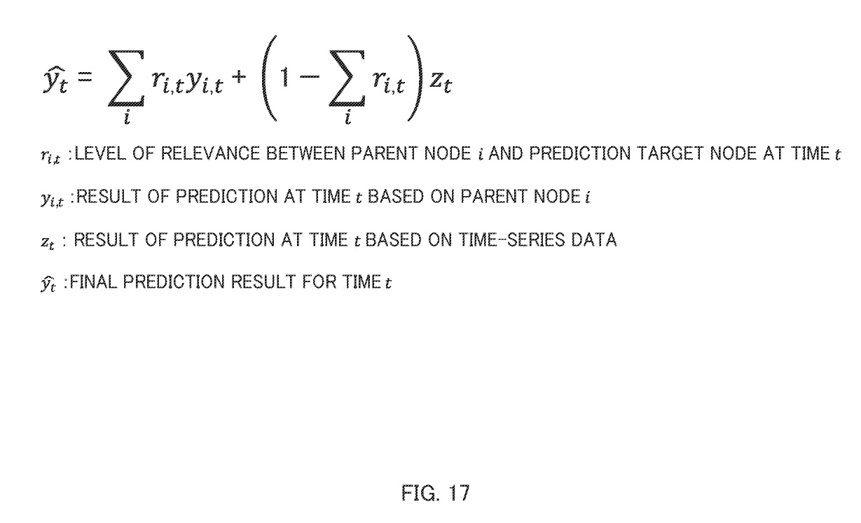

Referring back to FIG. 14, the transition prediction part 113 next integrates prediction results of the respective prediction models after weighing the prediction results using the relevance level between the nodes (S1406). A prediction result with a higher relevance level between nodes is weighed more, so that a prediction result on a parent node with a high relevance level may be emphasized. Specifically, for example, the transition prediction part 113 integrates the prediction results of the prediction models calculated in S1404 and S1405 based on a formula shown in FIG. 17.

The transition prediction part 113 predicts the transition of the transition index for every node by performing the above operation on all the nodes (S1407).

FIG. 2 is referred to again to continue the description. The prediction result display part 114 shown in FIG. 3 receives settings information for analysis from a user. Based on the settings information received as well as the causal relation data 121, the relevance level data 123, and the transition index data 124, the prediction result display part 114 activates the relevance level calculation processing S900 and the transition prediction processing S1400 described above, generates a screen to display the results, and displays the results on the output device 15.

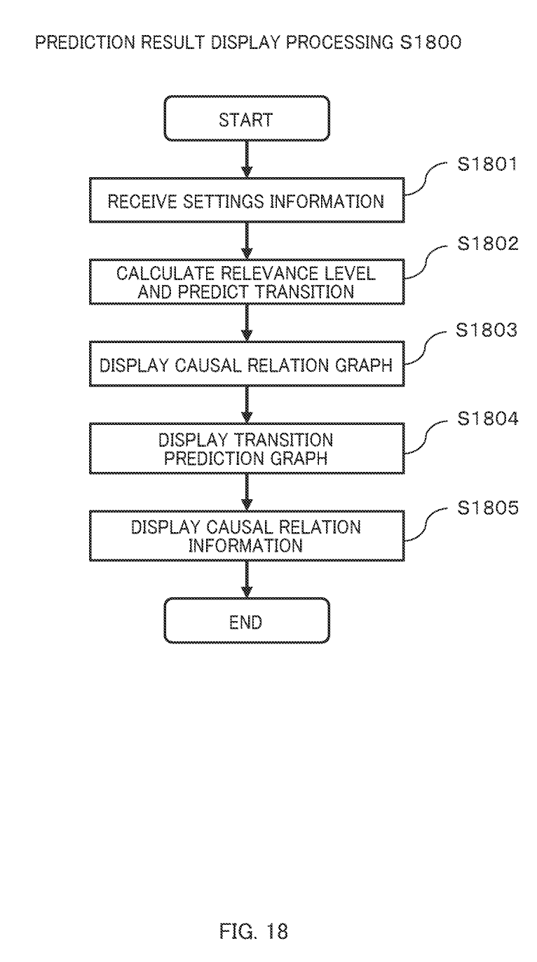

FIG. 18 is a flowchart illustrating processing performed by the prediction result display part 114 (hereinafter called prediction result display processing S1800). The prediction result display processing S1800 is described below using FIG. 18.

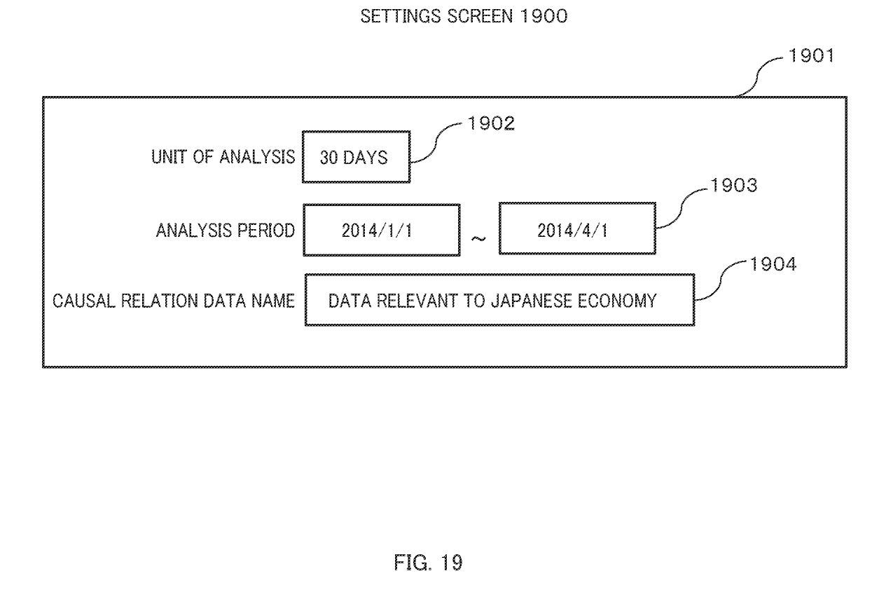

The prediction result display part 114 displays the settings screen 1900 shown in FIG. 19 and receives settings information from a user (S1801). In a unit of analysis 1902 of the settings screen 1900, the user designates a unit of data analysis (such as 30 days). In an analysis period 1903, the user designates a period for which data used in the analysis is covered. In a causal relation data name 1904, the user designates the name of the causal relation data 121 used in the analysis.

Referring back to FIG. 18, based on the settings information received in S1801, the prediction result display part 114 activates the relevance level calculation processing S900 performed by the relevance level calculation part 112 and the transition prediction processing S1400 performed by the transition prediction part 113 (S1802).

Next, the prediction result display part 114 generates and displays a screen having results of the transition prediction processing S1400 (hereinafter called prediction result display screen 2000).

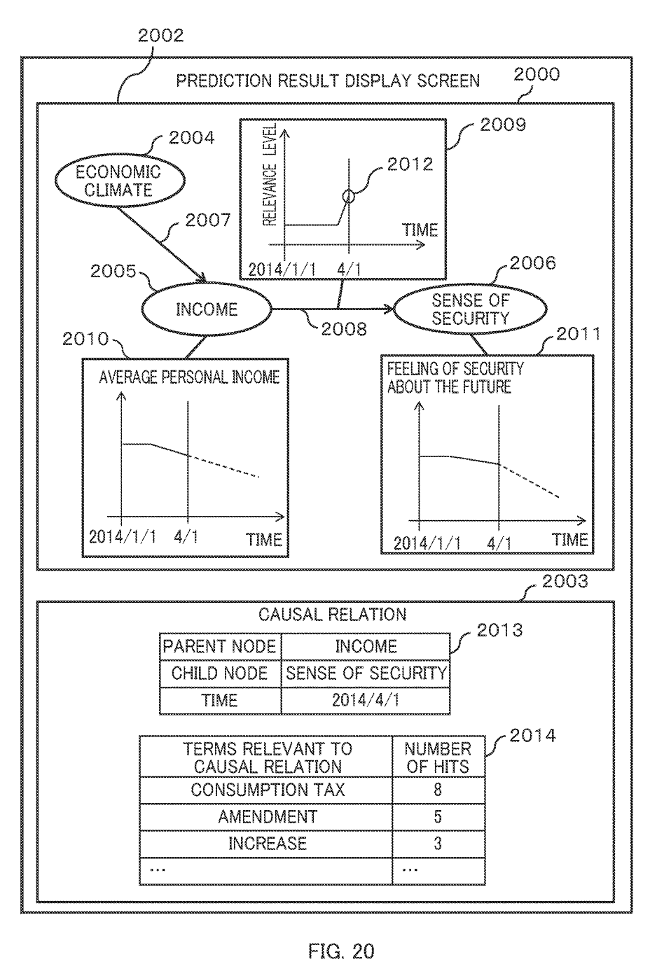

FIG. 20 illustrates an example of the prediction result display screen 2000. As shown in FIG. 20, the prediction result display screen 2000 has a prediction result display region 2002 and a causal relation relevant information display region 2003.

The prediction result display part 114 refers to the causal relation data 121 and the relevance level data 123 and generates a graph representing the structure of causal relations. For example, as shown in FIG. 20, the prediction result display part 114 displays a graph formed by nodes 2004 to 2006 and directional edges 2007 to 2008 in the prediction result display region 2002, the graph being based on the node information data 301 and the causal relation information data 302.

The prediction result display part 114 displays the relevance level data body 702 of the relevance level data 123 as a relevance level transition graph 2009 in the prediction result display region 2002. As shown in FIG. 20, the prediction result display part 114 displays the relevance level transition graph 2009 in association with the directional edge 2007 or 2008 based on the relevant causal relation ID 701. The directional edge 2007 and 2008 may change visually depending on the relevance level, such as a thicker line for a higher relevance level. In addition, as indicated by reference numeral 2012, a point of large change in the relevance level may be emphatically shown (such as by being circled).

As described, from the content displayed in the prediction result display region 2002, a user of the time-series prediction apparatus 10 can easily understand how the strength of the causal relation between matters changes with time. In the example shown in FIG. 20, the user can easily understand, based on the increase on the level of relevance between “income” and “sense of security”, that the impact of “income” on a “sense of security” has increased.

Referring back to FIG. 18, with reference to the transition index name 1202 and the transition index body 1203 of the transition index data 1202, the prediction result display part 114 generates and displays a graph representing the predicted transition of the transition index (hereinafter called a transition prediction graph) (S1804). For example, as shown in FIG. 20, the prediction result display part 114 displays the transition index name 1202 and the transition index body 1203 as a transition prediction graph 2010. Such a graph enables the user to understand the transition of the matter intuitively.

In the causal relation relevant information display region 2003, the prediction result display part 114 displays information on a single target causal relation at the designated time (S1805). In a causal relation designation field 2013 of the causal relation relevant information display region 2003, the user can designate a causal relation and time the information on which is to be displayed. When a user selects the point of change 2012 in the relevance level transition graph 2009, information on the causal relation and time corresponding to the point of change 2012 may be displayed automatically.

The prediction result display part 114 extracts the time-series data 122 containing both of the relevant keyword 305 of the parent node and the relevant keyword 305 of the child node within a time period designated, and in the causal relation relevant term display part 2014, displays terms included in the extracted time-series data 122 in descending order of appearance frequency. In a case where the level of relevance has changed with time, a user can find out a cause of the change in the causal relation by referring to the terms thus displayed. For instance, in the example shown in FIG. 20, a user can see, from the relevance level transition graph 2009, that the level of relevance between the parent node “income” and the child node “sense of security” has increased. Since terms such as “consumption tax”, “system”, and “increase” are displayed in descending order of appearance frequency in the causal relation relevant term display part 2014, the user can find that the impact of “income” on a “sense of security” has increased due to system amendment such as increase in the consumption tax rate.

As described thus far, the time-series prediction apparatus 10 of the embodiment takes the transition of a causal relation between matters as the transition of a level of relevance therebetween, and predicts the transition of time-series data using the relevance level. Thus, for example, the time-series prediction apparatus 10 of the embodiment can predict the transition of time-series data related to a social trend with high accuracy. The thus-obtained prediction results are useful in starting a profitable business that fits with the change in social trends, when used in, for example, making business plans for marketing or the like.

It should be noted that the present invention is not limited to the embodiment described above, and include various modifications thereof. For example, the embodiment described above has been given in a detailed manner in order to facilitate understanding of the present invention, and the present invention does not necessarily have to include all the configurations described above. Moreover, part of a configuration in a certain embodiment may be replaced by a configuration in another embodiment, or a configuration in a certain embodiment may be added to a configuration of another embodiment. Further, part of a configuration in each embodiment may be added to another configuration, deleted, or replaced with another configuration.

Some or all of the configurations, functions, processing units, processing means, and the like described above may be implemented by hardware using, for example, an integrated circuit designed to implement them. The configurations, functions, and the like described above may be implemented by software with a processor interpreting and executing programs for implementing the respective functions. Information used for the implementation of each function, such as programs, tables, and files may be stored in a recording device such as a memory, a hard disk, or an SSD (Solid State Drive) or a recording medium such as an IC card, an SD card, or a DVD.

Control lines and information lines illustrated are ones that are deemed necessary for the purpose of illustration. All the control lines and information lines necessary as products are not necessarily illustrated. Actually, almost all the configurations may be interconnected.

### REFERENCE SIGNS LIST

10 time-series prediction apparatus
50 Internet
111 time-series data collection part
112 relevance level calculation part
113 transition prediction part
114 prediction result display part
121 causal relation data
1221 time-series text data
1222 time-series numerical data
123 relevance level data
124 transition index data
301 node information data
302 causal relation information data
S700 time-series data collection processing
S900 relevance level calculation processing
S902 first feature amount calculation processing
S903 second feature amount calculation processing
S1400 transition prediction processing
S1800 prediction result display processing
1900 settings screen

1. A time-series prediction apparatus that predicts transition of time-series data on a matter, comprising:
a relevance level calculation part that calculates a relevance level which is an index of strength of a causal relation between a plurality of matters including a prediction target matter, based on time-series data relevant to each of the matters and on time-series data relevant to the causal relation between the matters; and
a transition prediction part that predicts transition of the time-series data relevant to the matter based on the relevance level.

2. The time-series prediction apparatus according to claim 1, wherein
the relevance level calculation part calculates the relevance level based on collocation frequency of terms relevant to the respective matters in the time-series data relevant to the causal relation between the matters.

3. The time-series prediction apparatus according to claim 1, wherein
based on time-series data relevant to a matter which is in a causal relation with the prediction target matter, the transition prediction part builds a plurality of prediction models for predicting the transition of the time-series data relevant to the prediction target matter, and
the transition prediction part integrates prediction results of the respective prediction models while weighing each of the prediction models according to the relevance level.

4. The time-series prediction apparatus according to claim 1, wherein
the time-series prediction apparatus generates a graph representing temporal transition of the time-series data.

5. The time-series prediction apparatus according to claim 4, wherein
the time-series prediction apparatus generates a graph representing temporal transition of the relevance level.

6. The time-series prediction apparatus according to claim 1, wherein
the time-series prediction apparatus extracts, from time-series data relevant to the causal relation between the matters, time-series data containing both of terms relevant to the respective matters, and generates information indicating appearance frequency of the terms included in the time-series data extracted.

7. The time-series prediction apparatus according to claim 1, further comprising a time-series data collection part that acquires, over the Internet, the time-series data relevant to each of the plurality of matters including the prediction target matter and the time-series data relevant to the causal relation between the matters.

8. A time-series prediction method executed using an information processing apparatus that predicts transition of time-series data on a matter, the method comprising the steps, performed by the information processing apparatus, of:
calculating a relevance level which is an index of strength of a causal relation between a plurality of matters including a prediction target matter, based on time-series data relevant to each of the matters and on time-series data relevant to the causal relation between the matters; and
predicting transition of the time-series data relevant to the matter based on the relevance level.

9. The time-series prediction method according to claim 8, further comprising the step, performed by the time-series prediction apparatus, of:
calculating the relevance level based on collocation frequency of terms relevant to the respective matters in the time-series data relevant to the causal relation between the matters.

10. The time-series prediction method according to claim 8, further comprising the steps, performed by the time-series prediction apparatus, of:
based on time-series data relevant to a matter which is in a causal relation with the prediction target matter, building a plurality of prediction models for predicting the transition of the time-series data relevant to the prediction target matter; and
integrating prediction results of the respective prediction models while weighing each of the prediction models according to the relevance level.

11. The time-series prediction method according to claim 8, further comprising the step, performed by the time-series prediction apparatus, of:
generating a graph representing temporal transition of the time-series data.

12. The time-series prediction method according to claim 11, further comprising the step, performed by the time-series prediction apparatus, of:
generating a graph representing temporal transition of the relevance level.

13. The time-series prediction method according to claim 8, further comprising the step, performed by the time-series prediction apparatus, of:
extracting, from time-series data relevant to the causal relation between the matters, time-series data containing both of terms relevant to the respective matters, and generating information indicating a frequency of appearance of the terms included in the time-series data extracted.

14. The time-series prediction method according to claim 8, further comprising the step, performed by the time-series prediction apparatus, of:
acquiring, over the Internet, the time-series data relevant to each of the plurality of matters including the prediction target matter and the time-series data relevant to the causal relation between the matters.
